(19) United States
(12) Patent Application Publication
(10) Pub. No.: US 2026/0152045 A1
(43) Pub. Date: Jun. 4, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/387,920

(22) Filed: Nov. 13, 2025

(30) Foreign Application Priority Data
Dec. 4, 2024 (JP) 2024-211721

(51) Int. Cl. B60H 3/02; B60H 1/00

(52) U.S. Cl. CPC B60H 3/02; B60H 1/00564

(57) ABSTRACT

A vehicle air conditioning system includes: a humidity controlling device having an adsorption portion, heating means, a duct having first and second flow paths; a valve; a blower; and a control unit to control the humidity controlling device, the valve and the blower. A control mode of the control unit includes: an adsorption mode in which the blower is activated and air flows into the first flow path without activating the heating means; and a regeneration mode in which the blower and the heating means are activated and air flows into the second flow path. The control unit executes the regeneration mode when the following conditions (1) and (2) are satisfied:
(1) an external power source is connected to the vehicle; and
(2) radio waves from an electronic key carried by a user are received or there is at least one occupant in the vehicle interior.

### FIELD OF THE INVENTION

The present invention relates to a vehicle air conditioning system.

### BACKGROUND OF THE INVENTION

A conventionally used air conditioning system for this type can include, for example, the structure disclosed in the following Patent Literature 1 and the like. Patent Literature 1 discloses “an electric vehicle anti-fogging and air conditioning system comprising a vehicle air conditioning device in which multiple dehumidifying units containing dehumidifying materials that generate moisture absorption functions are arranged inside a body of an electric vehicle that runs based on stored electricity as a main power source for an electric motor, wherein, when a battery is being charged, mainly at night, hot air is produced using electricity in parallel, and the hot air is used to heat and regenerate the dehumidifying materials in the dehumidifying units”.

### CITATION LIST

### Patent Literatures

[Patent Literature 1] Japanese Patent Application Publication No. 2011-121516 A

### SUMMARY OF THE INVENTION

When the heating of the adsorbent materials is stopped, the adsorbent materials (dehumidifying materials) may adsorb moisture without actively feeding air to the humidity controlling device (dehumidifying unit). The conventional configuration described above proposes heating and regeneration of the adsorbent materials in the humidity controlling devices during battery power storage. However, if there is a delay between the heating and regeneration of the adsorbent material and boarding, the adsorbent materials may absorb a larger amount of moisture by the time of boarding, which will require regeneration of the adsorbent materials again during boarding. In other words, in the conventional configuration, regeneration of adsorbent materials that are not useful may occur.

This invention has been made to solve the problems described above, and one of objects thereof is to provide a vehicle air conditioning system, which can more efficiently perform regeneration of an adsorbent in a humidity controlling device while utilizing electric power of an external powder source.

As results of intensive studies for vehicle air conditioning systems including humidity controlling devices, the inventor has found that the above problems can be solved by regenerating the adsorbent of the humidity controlling device when the external power source is connected to the vehicle and there is at least one occupant near the vehicle or in the vehicle interior.

[1] In an embodiment, this invention relates to a vehicle air conditioning system includes: a humidity controlling device including an adsorption portion containing an adsorbent configured to adsorb moisture at a temperature lower than or equal to a predetermined temperature and to desorb the moisture when a temperature exceeds the predetermined temperature, and a heating means configured to heat the adsorption portion; a duct having the humidity controlling device provided therein and allowing air from a vehicle interior or a vehicle exterior to flow therethrough, the duct having a first flow path for allowing the air to flow into the vehicle interior on a downstream side of the humidity controlling device and a second flow path for discharging the air to the vehicle exterior; a valve configured to switch the flow of the air between the first flow path and the second flow path; and a blower for sending the air to the humidity controlling device; and a control unit for controlling the humidity controlling device, the blower and the valve, wherein a control mode of the control unit includes: an adsorption mode in which the blower is activated and the air is allowed to flow the first flow path without activating the heating means; and a regeneration mode in which the blower and the heating means are activated and the air is allowed to flow into the second flow path, and the control unit executes the regeneration mode when the following conditions (1) and (2) are satisfied: (1) an external power source is connected to the vehicle; and (2) radio waves are received from an electronic key carried by a user of the vehicle or there is at least one occupant in the vehicle interior.

[2] This invention may relate to the vehicle air conditioning system according to [1], wherein the control unit determines whether the conditions (1) and (2) are satisfied when a power source mode of the vehicle is OFF.

[3] This invention may relate to the vehicle air conditioning system according to [1] or [2], wherein the control unit determines whether the conditions (1) and (2) are satisfied when a power source mode of the vehicle is ACC or ON.

[4] This invention may be relate to the vehicle air conditioning system according to any one of [1] to [3], wherein the control unit executes the regeneration mode when the conditions (1) and (2) are satisfied but the following condition (3) is not satisfied, and the control unit alternatively executes the regeneration mode and the adsorption mode when the following condition (3) is satisfied in addition to the conditions (1) and (2):

(3) humidity in the vehicle interior is equal to or more than a predetermined threshold value.

[5] This invention may relate to the vehicle air conditioning system according to any one of [1] to [4], wherein the adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and wherein the heating means has a pair of electrodes connected to the honeycomb structure, the heating means being configured to heat the honeycomb structure by passing a current through the honeycomb structure via the pair of electrodes, and wherein at least the partition walls of the honeycomb structure are made of a material having a PTC property.

According to an embodiment of the vehicle air conditioning system of this invention, the control unit executes the regeneration mode when the above conditions (1) and (2) are satisfied, thereby enabling more efficient regeneration of the adsorbent of the humidity controlling device while utilizing electric power from the external power source.

### BRIEF DESCRIPTION OF THE DRAWINGS

FIG. 1 is a schematic view of a vehicle air conditioning system according to an embodiment of the invention;

FIG. 2 is a front view of a humidity controlling device in FIG. 1;

FIG. 3 is a right side view of a humidity controlling device in FIG. 2; and

FIG. 4 is an enlarged view illustrating a region IV in FIG. 2.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### 1. Vehicle Air Conditioning System

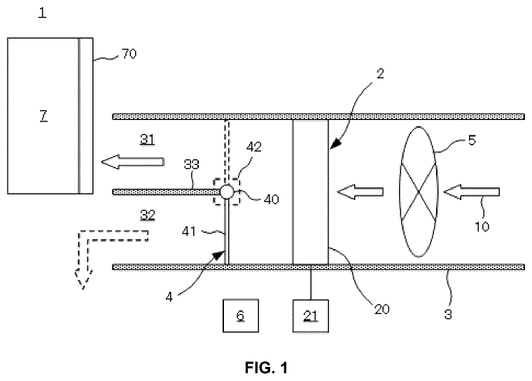

FIG. 1 is a schematic view of a vehicle air conditioning system 1 according to an embodiment of the invention. The vehicle air conditioning system 1 according to an embodiment is a system mounted on a vehicle. The vehicle is intended to be one to which an external power source is connected, for example, electric vehicles, plug-in hybrid vehicles and the like. The external power source can be comprised of, for example, a commercial power source or the like, which can be connected to the vehicle to charge a drive storage battery installed in the vehicle. The drive storage battery can supply electric power to a drive motor that rotates and drives the wheels when the vehicle is running.

As illustrated in FIG. 1, the vehicle air conditioning system 1 according to an embodiment of this invention includes a humidity controlling device 2, a duct 3, a valve 4, a blower 5, and a control unit 6.

The humidity controlling device 2 has an adsorption portion 20 and a heating means 21. The adsorption portion 20 contains an adsorbent capable of adsorbing moisture at a temperature lower than or equal to a predetermined temperature and desorbing the moisture when the temperature exceeds the predetermined temperature. The heating means 21 is configured to heat the adsorption portion 20. Heating of the adsorption portion 20 by the heating means 21 desorbs the moisture from the adsorbent in the adsorption portion 20.

The duct 3 is a pipe in which the humidify controlling device 2 is provided. The duct 3 is configured to allow an air 10 from a vehicle interior or a vehicle exterior to flow therethrough. The duct 3 has a first flow path 31 and a second flow path 32 on a downstream side of the humidity controlling device 2. The first flow path 31 is a flow path for allowing the air 10 that has passed through the humidity controlling device 2 to flow into the vehicle interior. The second flow path 32 is a flow path for discharging the air 10 that has passed through the humidity controlling device 2 to the vehicle exterior. The first flow path 31 and the second flow path 32 are separated from each other by a duct partition wall 33. Although not shown, the first flow path 31 and the second flow path 32 may be provided at a distance from each other.

The outlet of the first flow path 31 may be positioned to face an HVAC intake port 70 of an HVAC unit 7. The outlet of the second flow path 32 may be positioned so as to be displaced from the HVAC intake port 70. The HVAC unit 7 is a unit for performing heating, ventilation, and air conditioning in a vehicle. The HVAC unit 7 can send the air 10 drawn in from the HVAC intake port 70 to the vehicle interior. It is intended that the air 10 flowing through the first flow path 31 is fed to the vehicle interior through the HVAC unit 7, and the air 10 flowing through the second flow path 32 is discharged to the vehicle exterior without passing through the HVAC unit 7.

The valve 4 is configured to be able to switch the flow of the air 10 passing through the duct 3 between the first flow path 31 and the second flow path 32. The valve 4 can cause the air 10 to flow into the first flow path 31 when the moisture in the air 10 is adsorbed to the humidity controlling device 2, and can cause the air 10 to flow into the second flow path 32 when the moisture is desorbed from the humidity controlling device 2. FIG. 1 shows the air 10 being allowed to flow into the first flow path 31. The valve 4 is not particularly limited as long as it is a valve that is electrically driven and has the function of switching the flow path, and includes electromagnetic valves and electric valves. In an embodiment, the valve 4 includes an opening/closing door 41 supported by a rotating shaft 40 and an actuator 42 such as a motor that rotates the rotating shaft 40.

The blower 5 is configured to feed the air 10 to the humidity controlling device 2. The blower 5 may be provided inside the duct 3. The blower 5 may be provided upstream of the humidity controlling device 2 in the flow direction of the air 10.

The control unit 6 is composed of an ECU (Electronic Control Unit) or the like, and is configured to control the humidity controlling device 2, the valve 4, and the blower 5. The control unit 6 may be electrically connected to the humidity controlling device 2, the valve 4, and the blower 5 by wire or wirelessly. A control mode of the control unit 6 may include an adsorption mode in which the blower 5 is activated and the air 10 is allowed to flow into the first flow path 31 without activating the heating means 21, and a regeneration mode in which the blower 5 and the heating means 21 are activated and the air 10 is allowed to flow into the second flow path 32.

The control unit 6 executes the regeneration mode when the following conditions (1) and (2) are satisfied:
(1) An external power source is connected to the vehicle.
(2) Radio waves from an electronic key carried by a user of the vehicle are received or there is at least one occupant in the vehicle interior.

By executing the regeneration mode when the external power source is connected to the vehicle, the adsorbent of the humidity controlling device 2 can be regenerated while utilizing the electric power of the external power source. When the regeneration mode is executed, heating of the adsorption portion 20 by the heating means 21, control of the valve 4, and air blowing by the blower 5 are performed by the electric power from the external power source. There is no need to use electric power from the drive battery to regenerate the adsorbent.

Although not limited, the control unit 6 can detect that the external power source is connected to the vehicle based on an output signal of a voltage sensor for measuring the voltage of the drive battery or a circuit connected to the drive battery. The voltage sensor may be incorporated into a battery management system for managing the drive battery. When the control unit 6 detects the connection to the device, it inputs a regeneration command to the humidity controlling device 2, and the heating means 21 heats the adsorption portion 20 in response to the regeneration command.

If the adsorbent of the humidity controlling device 2 were to be regenerated independently of the occupant, the adsorbent would adsorb a large amount of moisture by having some time from the regeneration of the adsorbent and the occupant getting in, which causes a risk that the adsorbent would need to be regenerated again when the occupant gets in. In contrast, when radio waves are received from the electronic key carried by the use of the vehicle, it is considered that the occupant(s) will be near the vehicle and will soon get in the vehicle. As in the vehicle air conditioning system 1 according to this embodiment, the regeneration mode is executed when radio waves from the electronic key are received or when there is at least one occupant in the vehicle interior, so that the adsorbent of the humidity controlling device 2 can be regenerated more efficiently.

The electronic key is provided with a transmitter for emitting radio waves at a specific frequency. The vehicle is provided with a receiver for inputting a detection signal to the control unit 6 when it receives radio waves from the electronic key. The electronic key and the vehicle are provided with antennas for transmitting and receiving radio waves. The control unit 6 can detect radio waves being received from the electronic key based on signals from the receiver. Authentication information (ID) assigned to the vehicle and the electronic key, and when the electronic key is authenticated by sending and receiving authentication information between the vehicle and the electronic key, the doors can be unlocked and the engine or motor can be started. The vehicle transmits a polling signal, and when the electronic key receives the polling signal from the vehicle, it transmits authentication information to the vehicle via radio waves. The control unit 6 may execute the regeneration mode when the external power source is connected to the vehicle and when authentication information previously registered in the vehicle matches authentication information from the electronic key. The electronic key may also be called a smart key or a portable key.

The control unit 6 can detect the presence of the occupant in the vehicle interior based on signals from occupant detection sensors. The occupant detection sensors can include weight sensors that are provided in the seats and configured to detect the weights of the occupants when the occupants sit in the seats.

When the power source mode of the vehicle is OFF and the above conditions (1) and/or (2) are not satisfied, the control unit 6 does not execute the regeneration mode.

The control unit 6 determines whether the conditions (1) and (2) are satisfied when the power source mode of the vehicle is OFF. Additionally or alternatively, the control unit 6 may determine whether the conditions (1) and (2) are satisfied when the power source mode of the vehicle is ACC (accessory). Additionally or alternatively, the control unit 6 may determine whether the conditions (1) and (2) are satisfied when the power source mode of the vehicle is ON.

The power mode can be switched by operating the vehicle's start button or key cylinder. When the power source mode is OFF, pressing the start button without depressing the brake pedal changes the power source mode to ACC, and pressing the start button while depressing the brake pedal changes the power source mode to ON. It can also switch the power source mode to OFF, ACC, and ON depending on the position of the key inserted into the key cylinder. When the power source mode is OFF, power supply to accessory devices such as a car navigation system and driving devices such as a motor is stopped. However, even if the power source mode is OFF, electric power is still supplied to the control unit 6, and the control unit 6 is operable. When the power source mode is ACC, power supply to the driving device is stopped, while power supply to the accessory device is continued. When the power source mode is ON, electric power is supplied to the accessory device and the driving device. The sensor detects a change in voltage and/or current in response to the power source mode, and the control unit 6 can detect the power source mode of the vehicle based on the signal from the sensor.

The control unit 6 executes the regeneration mode when the conditions (1) and (2) are satisfied but the following condition (3) is not satisfied, and alternately executes the regeneration mode and the adsorption mode when the following condition (3) is satisfied in addition to the conditions (1) and (2):
(3) The humidity in the vehicle interior is equal to or higher than a predetermined threshold.

When the humidity in the vehicle interior is equal to or higher than the predetermined threshold, the adsorption mode can be executed in addition to the regeneration mode, thereby reducing the humidity in the vehicle interior. The control unit 6 can determine whether the humidity in the vehicle interior is equal to or higher than the predetermined threshold based on a signal from a humidity sensor configured to detect the humidity in the vehicle interior. The humidity sensor may be provided inside the vehicle interior. (3) The threshold value of the humidity in the vehicle interior includes 40%.

The period during which the regeneration mode is executed is referred to as a first period, and the period during which the adsorption mode is executed is referred to as a second period. The first period may be the same as the second period, but it may be longer or shorter than the second period. The first period and the second period may be consecutive in time, or a rest period may be provided between the first period and the second period. If the humidity in the vehicle interior is less than the predetermined threshold value while the regeneration mode and the adsorption mode are alternately executed, the adsorption mode may not be executed and only the regeneration mode may be executed.

The first period is preferably executed for 0.1 to 10 minutes, more preferably for 0.5 to 8 minutes, and even more preferably for 1 to 5 minutes. Alternatively, the relationship between the duration of the first period and the regeneration rate of the adsorption portion 20 may be determined in advance, and the duration of the first period may be set based on that relationship. Further, humidity sensors (not shown) may be installed upstream and downstream of the humidity controlling device 2, and the first period may be completed when a difference between the humidity sensors upstream and downstream approaches zero (when it is equal to or lower than the predetermined threshold).

The second period is preferably executed for 0.1 to 10 minutes, more preferably for 0.5 to 8 minutes, and even more preferably for 1 to 5 minutes. Humidity sensors (not shown) may be installed upstream and downstream of the humidity controlling device 2, and the second period may be completed when a difference between the humidity sensors upstream and downstream approaches zero (when it is equal to or lower than the predetermined threshold).

### 2. Regarding Humidity Controlling Device

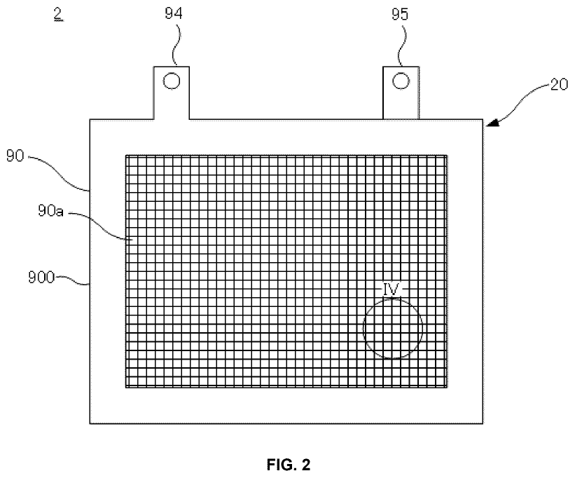

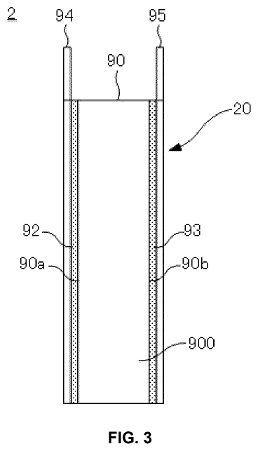

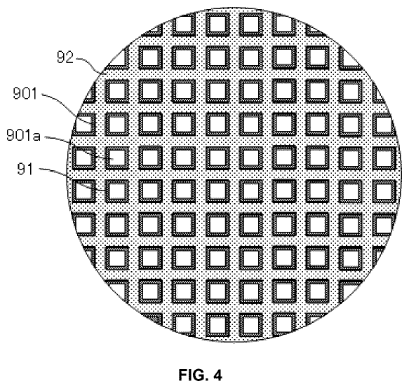

Next, FIG. 2 is a front view illustrating the humidity controlling device 2 in FIG. 1, FIG. 3 is a right side view illustrating the humidity controlling device 2 in FIG. 3, and FIG. 4 is an enlarged view illustrating the region IV in FIG. 2.

As illustrated in FIGS. 2 to 4, the adsorption portion 20 of the humidity controlling device 2 according to this embodiment has a honeycomb structure 90 and an adsorbing layer 91. The honeycomb structure 90 includes: an outer wall 900; and partition walls 901 provided on an inner side of the outer wall 900, the partition walls 701 defining cells 901a to form flow paths for the air 10 each extending from a first end face 90a to a second end face 90b of the honeycomb structure 90. The adsorbing layer 91 is a layer containing the adsorbent as described above, and is provided on each surface of the partition walls 901 as illustrated in FIG. 4. As the air 10 passes through the cells 901a between the first end face 90a and the second end face 90b, the moisture in the air 10 is adsorbed by the adsorbent in the adsorbing layer 91.

In such a humidity controlling device 2, the heating means 21 has a pair of electrodes 92, 93 connected to the honeycomb structure 90, and heats the honeycomb structure 90 by applying an electric current to the honeycomb structure 90 through the pair of electrodes 92, 93. Hereinafter, when the pair of electrodes 92, 93 are to be distinguished from each other, one will be referred to as a first electrode 92 and the other as a second electrode 93.

As particularly illustrated in FIG. 3, the first electrode 92 is provided on the first end face 90a of the honeycomb structure 90, and the second electrode 93 is provided on the second end face 90b of the honeycomb structure 90. The first electrode 92 and the second electrode 93 are provided on the end face of the outer wall 900, and also provided on the end face of the partition walls 901 as illustrated in FIG. 4. The first electrode 92 and the second electrode 93 do not plug the cells 901a. However, a part of cells 901a may be plugged by the first electrode 92 and/or the second electrode 93.

As shown in FIGS. 2 and 3, a first metal terminal 94 may be provided on the first electrode 92, and a second metal terminal 95 may be provided on the second electrode 93. The first metal terminal 94 and the second metal terminal 95 are formed as rectangular frames attached to the outer peripheral portions of the first end face 90a and the second end face 90b, respectively. The first metal terminal 94 and the second metal terminal 95 are provided with extending portions each extending from the rectangular frame outward in the width direction of the honeycomb structure 90.

A positive electrode of a power source (not shown) is connected to one extending portion of the first metal terminal 94 and the second metal terminal 95, and a negative electrode of the power source is connected to the other extending portion of the first metal terminal 94 and the second metal terminal 95. Assuming that the positive electrode is connected to an extending portion of the first metal terminal 94 and the negative electrode is connected to an extending portion of the second metal terminal 95, the current from the first metal terminal 94 spreads over the first end face 90a through the first electrode 92, flows through the honeycomb structure 90 in the extending direction of the cells 901a, and flows on the second end face 90b through the second terminal 93 into the second metal terminal 95. The current flows in such a manner, thereby heating the honeycomb structure 90 uniformly.

In the honeycomb structure 90, at least the partition walls 901 may be made of a material having a PTC (Positive Temperature Coefficient) property. Further, the material having the PTC property has characteristics such that when the temperature increases to exceed the Curie point, the resistance value is sharply increased, making it difficult for electricity to flow.

Hereinafter, each of the components of the humidity controlling device 2 will be described in detail.

### (2-1. Regarding Honeycomb Structure)

The shape of the honeycomb structure 90 is not particularly limited. For example, an outer shape of a cross section of the honeycomb structure 90 orthogonal to the flow path direction (extending direction of the cells 901a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 90a and second end face 90b) have the same shape as the cross section. Also, when the cross section and the end faces are polygonal, the corners may be chamfered.

The shape of each cell 901a is not particularly limited, but it may be polygonal such as quadrangular, pentagonal, hexagonal, heptagonal, and octagonal, circular, or oval in the cross section of the honeycomb structure 90 orthogonal to the flow path direction. These shapes may be alone or in combination of two or more. Moreover, among these shapes, the quadrangle or the hexagon is preferable. By providing the cells 901a having such a shape, it is possible to reduce the pressure loss when the air 10 flows. In FIGS. 2 to 4, the honeycomb structure 90 is illustrated as an example in which the outer shape of the cross section and the shape of each cell 901a are quadrangular in the cross section orthogonal to the flow path direction of the honeycomb structure 90.

The honeycomb structure 90 may be a honeycomb joined body that includes a plurality of honeycomb segments and joining layers that join outer peripheral side surfaces of the plurality of honeycomb segments together. The use of the honeycomb joined body can increase the total cross-sectional area of the cells 901a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 900 and the partition walls 901. In addition to the role of joining the honeycomb segments to each other, the joining material can also be used as an outer peripheral coating material after joining the honeycomb segments.

From the viewpoints of ensuring the strength of the honeycomb structure 90, reducing pressure loss when the air 10 passes through the cells 901a, ensuring the amount of functional material supported, and ensuring the contact area with the air 10 flowing inside the cells 901a, it is desirable to suitably combine a thickness of the partition wall 901, a cell density, and a cell pitch (or an opening ratio of the cells 901a).

As used herein, the cell density refers to a value obtained by dividing a number of cells by an area of one end face (first end face 90a or second end face 90b) of the honeycomb structure 90 (the total area of the partition walls 901 and the cells 901a excluding the outer wall 900).

As used herein, the cell pitch refers to a value obtained by the following calculation. First, the area of one end face (first end face 90a or second end face 90b) of the honeycomb structure 90 (the total area of the partition walls 901 and the cells 901a excluding the outer wall 900) is divided by the number of the cells to calculate an area per a cell. A square root of the area per a cell is then calculated, and this is determined to be the cell pitch.

As used herein, the opening ratio of the cells 901a refers a value obtained by dividing the total area of the cells 901a defined by the partition walls 901 by the area of one end face (first end face 90a or second end face 90b) (the total area of the partition walls 901 and the cells 901a excluding the outer wall 900) in the cross section orthogonal to the flow path direction of the honeycomb structure 90. In addition, when calculating the opening ratio of the cells 901a, the first electrode 92, the second electrode 93, and an adsorbing layer 91 as described below are not taken into consideration.

In an embodiment that is advantageous from the viewpoint of supporting a sufficient amount of functional material, the thickness of the partition walls 901 is 0.300 mm or less, the cell density is 140 cells/cm² or less, and the cell pitch is 0.85 mm or more. In a preferred embodiment, the thickness of the partition walls 901 is 0.200 mm or less, the cell density is 120 cells/cm² or less, and the cell pitch is 0.91 mm or more. In a more preferred embodiment, the thickness of the partition walls 901 is 0.160 mm or less, the cell density is 110 cells/cm² or less, and the cell pitch is 0.95 mm or more.

In each embodiment as described above, from the viewpoints of ensuring the strength of the honeycomb structure 90 and maintaining lower electrical resistance, the lower limit of the thickness of the partition walls 901 is preferably 0.010 mm or more, more preferably 0.020 mm or more, and even more preferably 0.030 mm or more.

In each embodiment as described above, from the viewpoints of ensuring the strength of the honeycomb structure 90, maintaining lower electrical resistance, and increasing a surface area to facilitate reaction, adsorption, and separation, the lower limit of the cell density is preferably 30 cells/cm² or more, more preferably 35 cells/cm² or more, and even more preferably 40 cells/cm² or more.

In each embodiment as described above, from the viewpoints of ensuring the strength of the honeycomb structure 90, maintaining lower electrical resistance and increasing a surface area to facilitate reaction, adsorption and release, the upper limit of the cell pitch is preferably 2.0 mm or less, more preferably 1.8 mm or less, and even more preferably 1.6 mm or less.

In an embodiment that is advantageous in terms of both reducing pressure loss and maintaining strength, the thickness of the partition walls 901 is 0.08 to 0.36 mm, the cell density is 2.54 to 140cells/cm² , and the opening ratio of the cells 901a is 0.70 or more. In a preferred embodiment, the thickness of the partition walls 901 is 0.09 to 0.35 mm, the cell density is 15 to 100cells/cm² , and the opening ratio of the cells 901a is 0.80 or more. In a more preferred embodiment, the thickness of the partition walls 901 is 0.14 to 0.30 mm, the cell density is 20 to 90cells/cm² , and the opening ratio of the cells 901a is 0.85 or more.

In each embodiment as described above, from the viewpoint of ensuring the strength of the honeycomb structure 90, the upper limit of the opening ratio of the cells 901a is preferably 0.94 or less, more preferably 0.92 or less, and even more preferably 0.90 or less.

Although the thickness of the outer wall 900 is not particularly limited, it is preferably determined based on the following considerations. First, from the viewpoint of reinforcing the honeycomb structure 90, the thickness of the outer wall 900 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 900 is preferably 1.0 mm or less, more preferably 0.5 mm, even more preferably 0.4 mm or less, and still more preferably 0.3 mm or less.

As used herein, the thickness of the outer wall 900 refers to a length, in a normal line direction of a side surface of the honeycomb structure 90, from a boundary between the outer wall 900 and the outermost cell 901a or the partition wall 901 to the side surface of the honeycomb structure 90 in the cross section orthogonal to the flow path direction of the honeycomb structure 90.

The length of the honeycomb structure 90 in the flow path direction and the cross-sectional area orthogonal to the flow path direction may be adjusted according to the required size of the humidity controlling device 2, and are not particularly limited. For example, when used in a compact humidity controlling device 2 while ensuring a predetermined function, the honeycomb structure 90 can have a length of 2 to 20 mm in the flow path direction and a cross-sectional area of 10 cm² or more orthogonal to the flow path direction. Although the upper limit of the cross-sectional area orthogonal to the flow path direction of the honeycomb structure 90 is not particularly limited, it is, for example, 300 cm².

The partition walls 901 forming the honeycomb structure 90 are made of a material that can be heated by electric conduction, specifically made of a material having the PTC property. Further, the outer wall 900 may also be made of a material having a PTC property, as with the partition walls 901, as needed. By such a configuration, the adsorbing layer 91 can be directly heated by heat transfer from the heat-generating partition walls 901 (and optionally the outer wall 900). Further, the material having the PTC property has characteristics such that when the temperature increases to exceed the Curie point, the resistance value is sharply increased, making it difficult for electricity to flow. Therefore, when the temperature of the humidity controlling device 2 becomes high, the partition walls 901 (and the outer wall 900 if necessary) have limited current flowing through them, thereby suppressing excessive heat generation of the humidity controlling device 2. Therefore, it is possible to suppress thermal deterioration of the adsorbing layer 91 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 170 Ω·cm or less, and more preferably 160 Ω·cm or less, and even more preferably 150 Ω·cm or less. As used herein, the volume resistivity at 25° C. of the material having the PTC property is measured according to JIS K 6271:2008.

From the viewpoints of creating a device that can be heated by electric conduction and have the PTC property, the outer wall 900 and the partition walls 901 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystal grains is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 900 and the partition walls 901 are substantially free of lead (Pb). Specifically, the outer wall 900 and the partition walls 901 preferably have a Pb content of 0.01% by mass or less, and more preferably 0.001% by mass or less, and still more preferably 0% by mass. The lower Pb content can allow the air 10 heated by contact with the heat-generating partition walls 901 to be safely applied to organisms such as humans, for example. In the outer wall 900 and the partition walls 901, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 900 and the partition walls 901 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 900 and the partition walls 901 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20°C.) is defined as the Curie point.

### (2-2. Regarding First Electrode and Second Electrode)

The first electrode 92 and the second electrode 93 are provided on the first end face 90a and the second end face 90b, respectively. Applying a voltage between the first electrode 92 and the second electrode 93 allows the honeycomb structure 90 to generate heat by Joule heat.

The first electrode 92 and the second electrode 93 may employ, for example, a metal or alloy containing at least one selected from Cu, Ag, Al, Ni and Si, although not particularly limited thereto. It is also possible to use an ohmic electrode capable of ohmic contact with the outer wall 900 and/or the partition walls 901 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 92 and the second electrode 93 may have a single-layer structure, or may have a laminated structure of two or more layers. When the first electrode 92 and the second electrode 93 have the laminated structure of two or more layers, the materials of the respective layers may be of the same type or of different types.

The thicknesses of the first electrode 92 and the second electrode 93 may be appropriately set according to the method for forming the first electrode 92 and the second electrode 93. The method for forming the first electrode 92 and the second electrode 93 includes metal deposition methods such as sputtering, vapor deposition, electrolytic deposition, and chemical deposition. Alternatively, the first electrode 92 and the second electrode 93 can be formed by applying an electrode paste and then baking it, or by thermal spraying. Furthermore, the first electrode 92 and the second electrode 93 may be formed by joining metal sheets or alloy sheets.

Each thickness of the first electrode 92 and the second electrode 93 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. Regarding First Metal Terminal and Second Metal Terminal)

The provision of the first metal terminal 94 and the second metal terminal 95 facilitates connection to an external power source. The first metal terminal 94 and the second metal terminal 95 are connected to a conductor connected to the external power source.

The metal that makes up the first metal terminal 94 and the second metal terminal 95 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe-Ni alloy, and phosphor bronze. Furthermore, the thickness of each of the first metal terminal 94 and the second metal terminal 95 is not particularly limited, but it is, for example, 0.01 to 10 mm, typically 0.05 to 5 mm.

The method of connecting the first metal terminal 94 and the second metal terminal 95 to the first electrode 92 and the second electrode 93, respectively, is not particularly limited as long as they are electrically connected. For example, they can be connected by diffusion bonding, a mechanical pressing mechanism, welding, or the like.

### (2-4. Regarding Intermediate Material)

Intermediate materials may be provided between: the first electrode 92 and the second electrode 93; and the first metal terminal 94 and the second metal terminal 95. The provision of the intermediate materials results in high structural freedom of the connection between the first electrode 92 and the second electrode 93 and the first metal terminal 94 and the second metal terminal 95. The intermediate material may be made of non-limiting materials, and it may be the same as the material of the first metal terminal 94 and the second metal terminal 95 as described above. Moreover, the material of the intermediate material may be different from that of the first metal terminal 94 and the second metal terminal 95 as described above. In this case, the intermediate material can be made of a solder, a brazing material, a conductive adhesive, or the like. The method of connecting the intermediate materials to the first metal terminal 94 and the second metal terminal 95 and the first electrode 92 and the second electrode 93 is not particularly limited as long as they are electrically connected. For example, they can be connected by diffusion bonding, a mechanical pressing mechanism, welding, or the like.

### (2-5. Regarding Adsorbing Layer)

As illustrated in FIG. 4, the humidity controlling device 2 may be provided with an adsorbing layer 91 on each surface of the partition walls 901. The adsorbing layer 91 can be provided on the surfaces of the partition walls 901 (in the case of the outermost cells 901a, the partition walls 901 that define the outermost cells 901a and the outer wall 900). By thus providing the adsorbing layer 91, the functional material contained in the adsorbing layer 91 can be easily heated, so that the desired function due to the functional material can be exerted.

The adsorbent contained in the adsorbing layer 91 is not particularly limited as long as it can exhibit the desired function. The adsorbent has a function of adsorbing moisture, carbon dioxide and/or volatile components in the air. The adsorbing layer 91 may further contain a catalyst. This can allow the adsorption target substances to be purified. By using the adsorbent in combination with the catalyst, the function of the adsorbent to capture the adsorption target substances can be improved.

The adsorbent preferably has a function that can adsorb the adsorption target substances, for example, moisture, carbon dioxide and volatile components, etc., at −20 to 40° C. and desorb them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the adsorption target substances. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 91 may be determined according to the size of the cells 901a, and is not particularly limited. For example, from the viewpoint of ensuring sufficient contact with the air 10, the thickness of the adsorbing layer 91 is preferably 20 μm or more, more preferably 25 μm or more, and even more preferably 30 μm or more. On the other hand, from the viewpoint of suppressing separation of the adsorbing layer 91 from the partition walls 901 and the outer wall 900, the thickness of the adsorbing layer 91 is preferably 400 μm or less, more preferably 380 μm or less, and even more preferably 350 μm or less.

The thickness of the adsorbing layer 91 is measured using the following procedure. Any cross section of the honeycomb structure 90 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 90. The thickness of each adsorbing layer 91 visually recognized from the cross-sectional image is calculated by dividing the cross-sectional area by the length of the cells 901a in the flow path direction. This calculation is performed for all the adsorbing layers 91 visually recognized from the cross-sectional image, and an average value thereof is determined to be the thickness of the adsorbing layer 91.

From the viewpoint that the functional material exerts a desired function in the humidity controlling device 2, an amount of the adsorbing layer 91 is preferably 50 to 500 g/L, more preferably 100 to 400 g/L, and even more preferably 150 to 350 g/L, based on the volume of the honeycomb structure 90. It should be noted that the volume of the honeycomb structure 90 is a value determined by the external dimensions of the honeycomb structure 90.

### (3. Regarding Method for Producing Humidity Controlling Device)

The method for producing the humidity controlling device 2 according to an embodiment of the invention is not particularly limited as long as it is a method having the characteristics as described above, and can be carried out in accordance with a known method. Hereinafter, the method for producing the humidity controlling device 2 according to an embodiment of the invention will be specifically described.

A method for producing the honeycomb structure 90 forming the humidity controlling device 2 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600°C./hour, and maintaining the temperature for 0.5 to 10 hours.

The maintaining of the honeycomb formed body at the maximum temperature of from 1360 to 1430° C. for 0.5 to 10 hours can provide the honeycomb structure 90 containing, as a main component, BaTiO3-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 90 can be densified.

Further, the heating rate of 20 to 600 °C/hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 90.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 90 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 92 and the second electrode 93 are formed on the honeycomb structure 90 thus obtained, whereby the humidity controlling device 2 can be produced. The first electrode 92 and the second electrode 93 can also be formed by metal deposition methods such as sputtering, vapor deposition, electrolytic deposition, and chemical deposition. Further, the first electrode 92 and the second electrode 93 can also be formed by applying an electrode paste and then baking it. Furthermore, the first electrode 92 and the second electrode 93 can also be formed by thermal spraying. The first electrode 92 and the second electrode 93 may be composed of a single layer, but may also be composed of a plurality of electrode layers having different compositions. A typical method for forming the first electrode 92 and the second electrode 93 will be described below.

First, an electrode slurry containing an electrode material, an organic binder, and a dispersion medium is prepared, and the first end face 90a or the second end face 90b of the honeycomb structure 90 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 90 is removed by blowing and wiping. The slurry can be then dried to form the first electrode 92 and the second electrode 93 on the first end face 90a or the second end face 90b of the honeycomb structure 90. The drying can be performed while heating the humidity controlling device 2 to a temperature of about 120 to 600° C., for example. Although a series of steps of coating, slurry removal, and drying may be performed only once, the steps can be repeated multiple times to provide the first electrode 92 and the second electrode 93 having desired thicknesses.

The first metal terminal 94 and the second metal terminal 95 are then placed at predetermined positions of the first electrode 92 and the second electrode 93, respectively, and the first electrode 92 and the second electrode 93 are connected to the first metal terminal 94 and the second metal terminal 95, respectively. As a method of connecting the first electrode 92 and the second electrode 93 to the terminals, the method described above can be used. Further, when the intermediate materials are provided between: the first electrode 92 and the second electrode 93; and the first metal terminal 94 and the second metal terminal 95, the intermediate material can be placed at a predetermined position of the first electrode 92 and the second electrode 93 and connected to each other, and then the first metal terminal 94 and the second metal terminal 95 can be placed at a predetermined position of the intermediate material and connected to each other. As a method for connecting these, the method as described above can be used.

It should be noted that the first metal terminal 94, the second metal terminal 95 and the intermediate material may be provided after the adsorbing layer 91 described below is formed.

The adsorbing layer 91 is then formed on each surface of the partition walls 901 and the like of the humidity controlling device 2 thus obtained, thereby obtaining a humidity controlling device with functional material-containing layers.

Although the method for forming the adsorbing layer 91 is not particularly limited, it can be formed, for example, by the following steps. The humidity controlling device 2 is immersed in a slurry containing a functional material, an organic binder, and a dispersion medium for a predetermined period of time, and an excess slurry on the end faces and the outer periphery of the honeycomb structure 90 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 91 on the surfaces of the partition walls 901. The drying can be performed while heating the humidity controlling device 2 to a temperature of about 120 to 600° C., for example. Although a series of steps of immersion, slurry removal, and drying may be performed only once, the steps can be repeated multiple times to provide the adsorbing layer 91 having the desired thickness on the surfaces of the partition walls 901 and the like.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### DESCRIPTION OF REFERENCE NUMERALS

1: vehicle air conditioning system
2: humidity controlling device
3: duct
4: valve
5: blower
6: control unit
10: air
20: adsorption portion
21: heating means
31: first flow path
32: second flow path
90: honeycomb structure
90a: first end face
90b: second end face
91: adsorbing layer
92: electrode
93: electrode
900: outer wall
901: partition wall

1. A vehicle air conditioning system, comprising:
a humidity controlling device having an adsorption portion containing an adsorbent configured to adsorb moisture at a temperature lower than or equal to a predetermined temperature and to desorb the moisture when the temperature exceeds the predetermined temperature, and a heating means configured to heat the adsorption portion;
a duct having the humidity controlling device provided therein and allowing air from a vehicle interior or a vehicle exterior of a vehicle to flow therethrough, the duct having a first flow path for allowing the air to flow into the vehicle interior on a downstream side of the humidity controlling device and a second flow path for discharging the air to the vehicle exterior;
a valve configured to switch the flow of the air between the first flow path and the second flow path;
a blower for feeding the air to the humidity controlling device;
a control unit configured to control the humidity controlling device, the valve and the blower,
wherein a control mode of the control unit includes: an adsorption mode in which the blower is activated and the air is allowed to flow into the first flow path without activating the heating means; and a regeneration mode in which the blower and the heating means are activated and the air is allowed to flow into the second flow path, and
the control unit executes the regeneration mode when the following conditions (1) and (2) are satisfied:
(1) an external power source is connected to the vehicle; and
(2) radio waves are received from an electronic key carried by a user of the vehicle or there is at least one occupant in the vehicle interior.

2. The vehicle air conditioning system of claim 1, wherein the control unit determines whether the conditions (1) and (2) are satisfied when a power source mode of the vehicle is OFF.

3. The vehicle air conditioning system of claim 1, wherein the control unit determines whether the conditions (1) and (2) are satisfied when a power source mode of the vehicle is ACC or ON.

4. The vehicle air conditioning system of claim 1, wherein the control unit executes the regeneration mode when the conditions (1) and (2) are satisfied but the following condition (3) is not satisfied, and the control unit alternatively executes the regeneration mode and the adsorption mode when the following condition (3) is satisfied in addition to the conditions (1) and (2):
(3) humidity in the vehicle interior is equal to or more than a predetermined threshold value.

5. The vehicle air conditioning system of claim 1, wherein the adsorption portion comprises:
a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and
wherein the heating means has a pair of electrodes connected to the honeycomb structure, the heating means being configured to heat the honeycomb structure by passing a current through the honeycomb structure via the pair of electrodes, and
wherein at least the partition walls of the honeycomb structure are made of a material having a positive temperature coefficient (PTC) property.
